(19) United States
(12) Patent Application Publication
(10) Pub. No.: US 2024/0255217 A1
(43) Pub. Date: Aug. 1, 2024

(54) Method and Apparatus for Re-Liquefying BOG

(71) Applicant: TGE Marine Gas Engineering GmbH, Bonn (DE)

(72) Inventor: Hans-Christian Haarmann-Kühn, Brühl (DE)

(73) Assignee: TGE Marine Gas Engineering GmbH, Bonn (DE)

(21) Appl. No.: 18/281,142

(22) PCT Filed: Mar. 11, 2022
(86) PCT No.: PCT/EP2022/056317

§ 371 Date: Apr. 2, 2024

(30) Foreign Application Priority Data
Mar. 11, 2021 (DE) 10 2021 105 999.2

(51) Int. Cl. F25J 1/00; F17C 5/04

(52) U.S. Cl. CPC F25J 1/0025; F17C 5/04; F17C 2221/035; F17C 2223/0153; F17C 2250/0408; F17C 2250/043; F17C 2265/034; F17C 2265/037

(57) ABSTRACT

The invention relates to a method for reliquefying boil-off gas (BOG) containing volatile components, the method comprising the following steps: a) compressing a BOG stream, wherein the BOG stream exits a final compression stage as a finally compressed BOG stream having a final pressure; b) condensing the finally compressed BOG stream to obtain an at least partly condensed, finally compressed fluid stream; c) providing a fluid receptacle having a fluid stream inlet and a fluid stream outlet, wherein the position of the fluid stream outlet is selected such that it is above a predefined fluid containment volume; d) feeding the fluid stream from step b) through the fluid stream inlet into the fluid receptacle; e) setting a liquid level setpoint for the fluid receptacle such that the liquid level setpoint is at the level of the upper edge of the fluid stream outlet or a predefined amount above it; f) setting an upper final pressure limit for the final compression stage; g) measuring the liquid level in the fluid receptacle; h) measuring the final pressure; i) discharging a fluid stream from the fluid receptacle through the fluid stream outlet; j) cooling the fluid stream from step i) to a temperature equal to the saturation temperature of the fluid stream at a pressure lower than the final pressure, in order to condense gaseous components of the fluid stream; k) transferring the cooled fluid stream when the measured liquid level is at least equal to the liquid level setpoint and/or when the measured final pressure is equal to the final pressure limit. The invention also relates to an apparatus for carrying out the method.

The invention relates to a method for reliquefying BOG (boil-off gas) containing (particularly) volatile components such as ethane, and to an apparatus for carrying out the method.

BOG is liquefied gas that has evaporated. Liquefied gases and thus BOG are generally mixtures of substances having components whose evaporation points usually differ from each other. BOG is produced by unavoidable heat ingress into the liquefied gas tanks (also referred to for short in the following as tanks) in which liquefied gas is either stored on the mainland, or transported or carried as fuel for own consumption on ships, for example, and/or into the pipelines in which liquefied gas flows. An increased proportion of volatile components has been detected increasingly frequently in liquefied gas recently. For example, LPG cargoes (e.g., commercial propane) with an increased ethane content in the range of 5 mol % to 8 mol % in the tank liquid are now commonplace. As a consequence, the long-known reliquefaction processes during transportation are no longer able to condense the increased proportion of volatile components. Non-condensable fractions ensue.

Reliquefaction of BOG is desirable for environmental and cost efficiency reasons, in particular to reduce emissions of hydrocarbon gases during normal operation, as well as the loss of cargo.

The problem of non-condensable fractions in the cargo gases has long been known in the operation of reliquefaction processes. Several solutions are established on the market:
One effective remedy is to vent to the atmosphere during the initial operating period if the amount of non-condensable substances is small (e.g., residual nitrogen from tank purging). This solution cannot be used if the non-condensable component is a normal component of the cargo and the amount of gas to be vented would become too large.
Residual gas condensers are heat exchangers that are fed the non-condensable gas fraction from the condenser via an automatically or manually operated venting valve on the condenser. This heat exchanger cools the gas mixture, which is almost below the final pressure of the compressor, to a temperature level close to the saturation temperature of the tank. Most of the high-boiling hydrocarbons are condensed in this way, and the small remaining amount of BOG that results is enriched with non-condensable gas. This is an efficient means for reducing cargo losses. This process significantly reduces the available cooling capacity for cooling the tanks, as the cooling medium used in this process is usually condensate from liquefaction at storage pressure. It can be applied to low concentrations of volatile cargo components and can also be used to recover cargo during product changeovers.
Cascade cooling is also used. Many vessels, especially semi-refrigerated ones, are designed to transport ethane/ethylene as pure cargo. This is done in a cooling cascade with a refrigerant system that provides a temperature level for condensation of down to −40° C. This is also suitable for treating any type of commercial LPG at a pressure level achievable by two-stage compression. The disadvantage of this method is the complexity and cost of the machinery and equipment required for the additional cascade system.
Recent years have seen the development of vent coolers such as those known from WO 2012/143699 A1, where reliquefaction is carried out by means of a two-stage reliquefaction process in a cargo condenser using seawater as refrigerant. The development described in WO 2012/143699 A1 is basically similar to a residual gas condenser. The technological advantage is that the temperature level is linked to the intermediate pressure between the two compression stages and not to the tank pressure. This normally suffices for condensing the cargo. At the same time, the cooling capacity of the system is less heavily reduced in comparison with a residual gas condenser.
In DE 10 2013 101 414 A1, it is proposed that tank liquid be fed into an economizer. This approach exploits the fact that tank liquid has a significantly lower concentration of volatile components than vapor (BOG). Loading the economizer with tank liquid instead of condensate from the liquefier reduces the concentration of the volatile components in the BOG stream from the economizer to the second compression stage, thus allowing a two-stage compressor system to also be operated under warm-water conditions. The disadvantage is that the tank liquid must be pressurized for injection, which requires additional equipment and makes the process more complex.

However, even these two-stage reliquefaction processes known from the prior art have difficulty handling cargoes with an elevated proportion of volatile components, e.g., of ethane. Ethane is the more volatile component, and its concentration in the BOG is much higher than its concentration in the liquid phase of the liquefied gas, which is also referred to in the following as bulk liquid.
The use of three-stage compressors is also known from the prior art: By using three-stage compressors, the condensation temperature at discharge pressure can be raised to a level that is easily reachable under world trade conditions and even for warm seawater. The disadvantage of this obvious approach are high costs of investment in the more sophisticated equipment.

Ethane contents of 2.5%, 5% and 8% in the bulk liquid are standard cargo specifications for which LPG systems are designed. For larger LPG systems, IMO Type A tanks with tank operating pressures between 0 and 0.4 bar g (0 kPag and 40.53 kPag) are typically relevant. The BOG compositions resulting from the ethane contents specified above require an increasing condensation pressure at a given temperature level. As mentioned above, the use of two-stage reciprocating compressors and seawater is state of the art in LPG reliquefaction. For worldwide use, seawater at 32° C. is taken into account. However, conditions in many ports and key trading areas tend to be warmer than that.

It is obvious that, for the standard compressor configuration, handling ethane concentrations of more than about 3.5% in the bulk liquid is not always feasible in all ambient conditions. In these cases, the standard approach is to install vent valves on the LPG condensers to blow off a portion of the gas that is not condensable under the available combination of pressure and temperature.

A typical situation is shown in the following numerical example:

The BOG concentration of ethane for a 5% ethane cargo is about 26% for a fully cooled tank (at 1 bar a (100 kPa)). At a temperature of 36° C., this mixture can be easily managed by a two-stage compressor with a maximum discharge pressure of 21 bar a (2.1 MPa).

At a condensation temperature of 40° C. (as a result of warm seawater or dirty heat exchangers), approximately 3 mol % of BOG remains in the vapor phase. This amount reacts very sensitively to slight variations in the composition of the tank liquid. For example, a very small increase in ethane content to only 5.5% will increase the latter amount to 14%.

In normal operation, this gas is either vented to the atmosphere, which means not only an undesirable release of greenhouse gases but also a loss of cargo, or it is returned to the tank as vapor, significantly reducing the available cooling capacity as a consequence.

In contrast, the object of the present invention is to propose a method and an apparatus with which BOG having a higher proportion of volatile components can also be reliquefied, and which are cost-efficient.

According to the invention, this object is achieved by a method according to claim 1 and an apparatus according to claim 11.

By means of the measures according to the invention, BOG with a high content of volatile components can be reliquefied with relatively little effort and expense.

The invention is based on the realization that the liquid phase portion in a partly condensed fluid can be increased in a simple manner if a liquid level setpoint is predefined for a fluid receptacle for receiving the partly condensed fluid, and a maximum final pressure, i.e., a final pressure limit, is predefined for the final pressure, and the discharge of the fluid from a cooling device downstream from the fluid receptacle, in which the fluid is cooled with a temperature that is predefined as a function of the final pressure, is released exclusively on condition of the liquid level setpoint being reached or exceeded, or on condition of the final pressure limit being reached.

By predefining a maximum final pressure limit for the final compression stage, it is accepted that BOG might not be compressed to the final pressure that would be necessary for complete condensation of all the volatile components in the condenser that follows, if it contains volatile components (e.g., a high percentage of ethane) or the condensation temperature is high (e.g., due to warm water or a dirty condenser) and the final compression pressure would therefore have to increase further. This leads to a situation where the gas phase fraction in the partly condensed fluid increases and the liquid level in the fluid receptacle falls. As a liquid level setpoint has been set and the upper edge of the fluid stream outlet of the fluid receptacle is at the level of this liquid level setpoint, or a predefined amount below it, only liquid fluid flows to the cooling device until the liquid level falls below the upper edge of the fluid stream outlet. Due to the measurement of the liquid level, furthermore, the actuator only transfers the cooled fluid stream until the level falls below the liquid level setpoint, thus ensuring that only liquid is transferred by the actuator until the final pressure limit is reached.

When the actuator is closed, the fluid stream backs up, and the fluid in the cooling device is cooled further. Due to this backing-up, the liquid level in the fluid receptacle starts rising again. If the gas phase fraction in the BOG stream continues to increase, the final pressure also increases. As the final pressure increases, the condensation temperature also increases, i.e., condensation in the negative temperature range is achieved with refrigerant that is less cold. When an appropriately specified final pressure limit is reached, it is therefore possible to completely condense the gas phase of the fluid with relatively “warm” refrigerant in the cooling device, or by far the largest proportion of the volatile components of the fluid, at least. The actuator is therefore reopened when the final pressure limit is reached, even if the liquid level setpoint has not yet been reached again in the fluid receptacle, and due to the complete or at least extensive condensation, a completely or largely liquid fluid stream is discharged from the cooling device.

When the volatile fraction in the BOG decreases again, the gas phase fraction in the partly condensed fluid also decreases, the liquid level in the fluid receptacle rises again, and the final compression pressure falls again. If the final compression pressure falls below the final pressure limit, the actuator is closed and remains closed until the liquid level reaches the liquid level setpoint again. Fluid with a significant gas phase fraction is thus prevented from being transferred out of the cooling device. The actuator is not reopened until the liquid level reaches or exceeds the liquid level setpoint. It can be opened within a continuous control loop.

The measures according to the invention thus allow even BOG containing volatile components to be reliquefied at little cost and effort.

The actuator is preferably a valve. Transfer of the fluid stream cooled in the cooling device can be controlled cost-efficiently by means of a valve. The valve may be part of the cooling device and be disposed directly at its fluid stream outlet. However, the valve may also be disposed in a fluid stream discharge line in flow connection with the fluid stream outlet of the heat exchanger. It is also conceivable that the valve is part of a liquefied gas tank or appliance into which the cooled fluid stream is to be fed.

It is also conceivable that the actuator is a volumetric conveying device, for example a turbine, which is then speed-controlled, for example, and which pauses, i.e., stops, the flow of cooled fluid at speed zero.

In step j), cooling is preferably carried out by means of a refrigerant circuit in which a refrigerant flows through a heat exchanger, the fluid stream from step i) being fed into the heat exchanger and the cooled fluid stream being discharged from the heat exchanger. In this way, the fluid stream can be cooled cost-efficiently.

A liquid refrigerant flows advantageously through the heat exchanger, and the refrigerant is stored in a refrigerant storage tank, wherein the refrigerant in the lower region of the refrigerant storage tank is in its liquefied phase and in the upper region is in its gaseous phase. A liquid refrigerant ensures good heat transfer, and a refrigerant storage tank ensures that the heat exchanger is supplied with sufficient refrigerant at all times.

The refrigerant storage tank may be structurally separate from the heat exchanger, thus providing a high level of flexibility with regard to the spatial arrangement and making it easier to carry out maintenance and repair work.

Alternatively, the refrigerant storage tank can be integrated in the heat exchanger. This results in a compact, space-saving design. Nor is there any need to lay connecting pipelines, which reduces costs and also prevents heat ingress via such pipelines.

In a preferred embodiment of the invention, the method comprises the features of claim 6 and the apparatus comprises the features of claim 17. Here, the BOG is compressed in a two-stage process and reliquefied BOG is used as refrigerant. Due to the cooling device being connected to the BOG stream between the first compression stage and the final compression stage, on the one hand, and a feed valve which is opened exclusively to feed reliquefied BOG into the refrigerant circuit being disposed in the feed line, on the other hand, the pressure level in the refrigerant circuit is equal to the intermediate pressure level at the connection between the first compression stage and the final compression stage.

The reliquefied BOG entering the refrigerant circuit from the fluid receptacle where the final compression pressure prevails is therefore expanded as it enters and cools down. If the final compression pressure reaches the final pressure limit, the gaseous fluid entering the heat exchanger from the fluid receptacle is under a particularly high pressure, and the drop in pressure and hence the drop in temperature for the reliquefied BOG entering the refrigerant circuit is particularly large, with the result that the gaseous BOG in the heat exchanger is condensed completely or almost completely, at least.

It is particularly advantageous when the liquid stream to be fed as a refrigerant into the refrigerant circuit is removed from the fluid receptacle at the bottom thereof. This ensures in a simple manner that no gaseous fluid enters the refrigerant circuit.

In an advantageous development of the measures according to claim 8 or 19, the discharge point of the liquid refrigerant from the refrigerant storage tank is placed above the inlet of the refrigerant into the heat exchanger. This ensures, by gravity alone, that the heat exchanger has a sufficient supply of refrigerant.

The cooling device for cooling the fluid stream discharged from the fluid receptacle is preferably an ebullient cooling system. The technical resources needed for cooling are thus kept relatively small.

The finally compressed BOG stream is preferably condensed in the condenser by seawater, as the latter is particularly cost-efficient.

The invention shall now be described in greater detail and byway of example with reference to the drawings, in which:

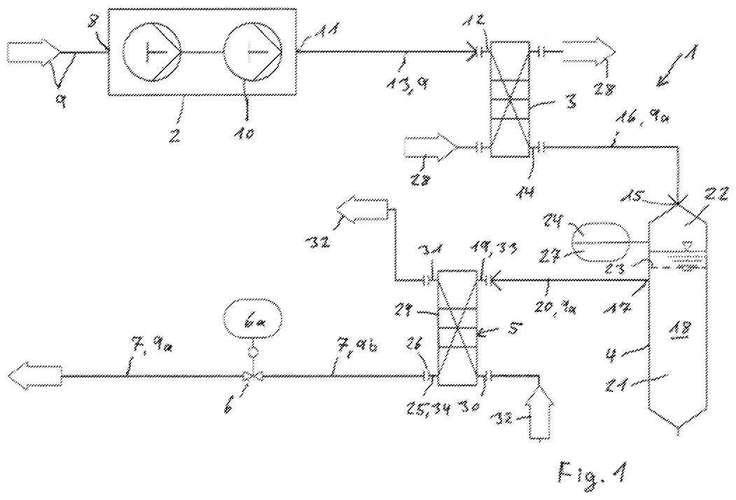

FIG. 1 shows a flow diagram of a first embodiment of an apparatus according to the invention and

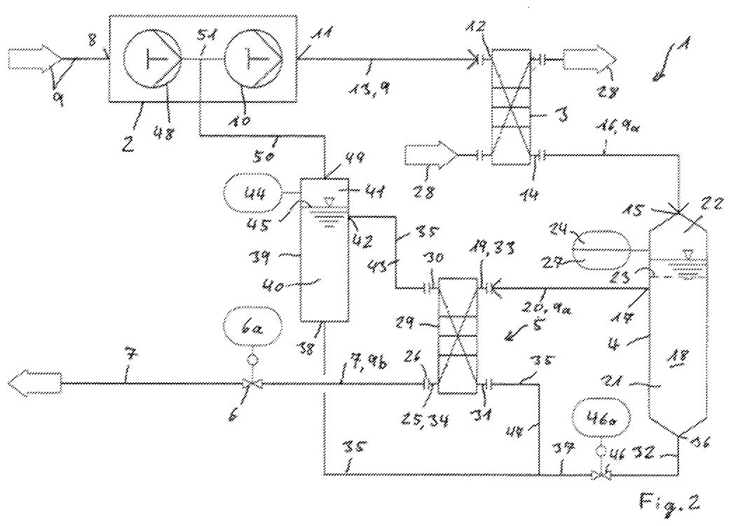

FIG. 2 shows a flow diagram of a second embodiment of an apparatus according to the invention.

The embodiments of apparatus 1 according to the invention, as shown in the Figures, have a compressor 2, a condenser 3, a fluid receptacle 4, a cooling device 5 and an actuator 6 which is provided in the form of a valve and which is disposed in a fluid stream discharge line 7.

Compressor 2 has an inlet 8 for a BOG stream 9. This inlet 8 may be in fluid connection with the gas phase region of a liquefied gas tank.

BOG stream 9 is compressed to a final pressure in the final compression stage 10 of compressor 2. The final pressure is dependent on the composition of the substance mixture that BOG stream 9 consists of, and increases with the proportion of volatile components in the substance mixture and BOG stream 9.

A two-stage or multistage compressor 2 is shown in the embodiment shown in FIG. 1, but in this embodiment compressor 2 can also be a single-stage compressor. In that case, the single compression stage is then also the final compression stage 10.

A final pressure limit is specified as a maximum final pressure for actuating actuator 6, i.e., the valve.

The final compression stage 10 has an outlet 11 for the finally compressed BOG stream 9, the outlet being in fluid connection 13 with a BOG stream inlet 12 of condenser 3. In condenser 3, the finally compressed BOG stream 9 is cooled with a temperature that is predefined independently of the final pressure. Condenser 3 can thus be cooled by seawater, for example.

In the case of a BOG stream 9 containing volatile components, it is therefore possible that the set final pressure limit is not sufficient to condense all the volatile components of the BOG stream with the available condenser temperature, with the result that BOG stream 9 is only partly condensed.

In the following, the BOG stream discharged from condenser 3 is referred to in general as fluid stream 9a, as it may contain liquid and/or gaseous components. The associated outlet is therefore referred to as fluid stream outlet 14.

The fluid stream outlet 14 of condenser 3 is in fluid connection 16 with a fluid stream inlet 15 of fluid receptacle 4.

Fluid receptacle 4 has a fluid stream outlet 17 that is above a predefined fluid containment volume 18 of fluid receptacle 4 and in fluid connection 20 with a fluid stream inlet 19 of cooling device 5.

In fluid receptacle 4, the gaseous phase and the liquefied phase of the fluid separate into a lower liquid phase region 21 and an upper gas phase region 22. A liquid level setpoint 23 for fluid receptacle 4 is set at the level of the upper edge of fluid stream outlet 17 or a predefined distance above it.

A level sensor 24 for measuring the liquid level is also arranged in fluid receptacle 4. The measurement signals are routed to a valve controller 6a with which valve 6 in the fluid stream discharge line downstream from the cooling device can be brought into an open position or into a closed position.

Cooling device 5 has the aforementioned fluid stream inlet 19 and a fluid stream outlet 25 which is in fluid connection 26 with fluid stream discharge line 7. Fluid stream 9a in cooling device 5 is cooled down to a temperature equal to the saturation temperature of fluid stream 9a at a temperature that is lower than the final pressure.

After its discharge from the final compression stage 10 of compressor 2, BOG stream 9 (referred to as fluid stream 9a after its discharge from condenser 3) is under the final pressure. This final pressure is measured by means of a pressure sensor 27 disposed anywhere in the region which extends from the discharge of BOG stream 9 from the final compression stage 10 of compressor 2 to valve 6 in fluid stream discharge line 7 downstream from cooling device 5 and which is under the final pressure. This pressure sensor 27 may be disposed in fluid receptacle 4, for example. The measurement signals are routed to a valve controller 6a with which valve 6 in fluid stream discharge line 7 can be brought into an open position or into a closed position. In the open position, reliquefied BOG is delivered to some further use, for example it is fed into a liquefied gas tank.

The actuator or valve position is thus controlled by means of the measurement signals not only from level sensor 24 but also from pressure sensor 27, as follows:
A) Open position

The actuator or valve 6 in fluid stream discharge line 7 is brought into an open position when
a) the liquid level is at least equal to liquid level setpoint 23 and/or
b) the final pressure reaches the final pressure limit.

### Case a)

Since the upper edge of the fluid stream outlet 17 of fluid receptacle 4 is at the level of liquid level setpoint 23 or a predefined amount below it, only fluid from its liquefied phase 21, i.e., only reliquefied BOG, flows into cooling device 5 and further into fluid stream discharge line 7 when liquid level setpoint 23 is reached.

### Case b)

When the final pressure limit is reached, the fluid is under a relatively high pressure, so cooling down to a temperature below the saturation temperature of the fluid stream at the final pressure limit produces a high level of further condensation of the gaseous components of fluid stream 9a, even when there is only slight cooling, for example by 1° K, and the fluid stream 9a discharged from cooling device 5 is almost entirely liquid or indeed exclusively liquid.

### B) Closed Position

The actuator of valve 6 in fluid stream discharge line 7 is brought into a closed position when
the liquid level falls below liquid level setpoint 23 and
the final pressure is below the final pressure limit.

If the proportion of non-condensed BOG increases (e.g., because the proportion of volatile components in the BOG has increased or because the seawater 28 in a seawater-cooled condenser 3 has become warmer), then the gas phase fraction 22 in the fluid increases (and the liquid phase portion 21 decreases), and the final pressure increases.

If the liquid level drops below liquid level setpoint 23 and then further below the upper edge of the fluid stream discharge port 17 of fluid receptacle 4, the boundary between the gaseous phase 22 and the liquefied phase 21 of the fluid is initially in the region of the fluid stream discharge port 17 of fluid receptacle 4. In this case, a mixture of gas and liquid is discharged from fluid receptacle 4 and enters cooling device 5.

If the liquid level falls to such an extent that fluid stream outlet 17 is entirely within the gas phase region 22 of fluid receptacle 4, then only gaseous BOG is discharged.

Since the actuator or valve 6 in fluid stream discharge line 7 downstream from cooling device 5 is closed, the fluid backs up, with the result that the liquid level in fluid receptacle 4 rises again. This is because, although the partly condensed BOG stream 9a exiting condenser 3 and entering fluid receptacle 4 contains an increased gas phase fraction, it still contains a liquid phase portion as well.

As mentioned above, with an increasing proportion of non-condensed components in the BOG, the final pressure increases, on the one hand, and the liquid level in fluid receptacle 4 increases, on the other hand, so as time progresses at least one of the two states described above under A)a) and A)b) is reached, and actuator or valve 6 is opened again.

FIG. 1 shows an embodiment of an apparatus 1 according to the invention that includes an external cooling device 5.

Cooling device 5 has a heat exchanger 29 that has an inlet 30 and an outlet 31 for refrigerant 32, as well as an inlet 33 and an outlet 34 for fluid stream 9a and 9b, respectively.

Heat exchanger 29 is part of an external refrigerant circuit.

The fluid stream inlet 33 of heat exchanger 29 is in fluid connection 20 with the fluid stream outlet 17 of fluid receptacle 4, and the fluid stream outlet 34 of heat exchanger 29 is connected to the fluid stream discharge line 7 of the cooling device.

In the embodiment shown in FIG. 2, reliquefied BOG is used as refrigerant 32.

Here, too, cooling device 5 includes a heat exchanger 29 that has an inlet 30 and an outlet 31 for refrigerant 32, as well as an inlet 33 and an outlet 34 for fluid stream 9a and 9b, respectively. Heat exchanger 29 is part of a refrigerant circuit 35.

As in the embodiment shown in FIG. 1, the fluid stream inlet 33 of heat exchanger 29 is in fluid connection 20 with the fluid stream outlet 17 of fluid receptacle 4, and the fluid stream outlet 34 of heat exchanger 29 is connected to the fluid stream discharge line 7 of the cooling device.

In the embodiment shown in FIG. 2, fluid receptacle 4 additionally includes a bottom outlet 36 which forms a second outlet of fluid receptacle 4, and is exclusively for reliquefied BOG, i.e., exclusively for a liquid stream.

Bottom outlet 36 is connected via a feed line 37 to the refrigerant inlet 38 of a refrigerant storage tank 39. In the embodiment shown, this refrigerant inlet 38 is disposed in the bottom of refrigerant storage tank 39.

Refrigerant 32, i.e., the reliquefied BOG used for this purpose, partly evaporates again in refrigerant circuit 35 (in particular in heat exchanger 29), so the refrigerant 32 is present in its liquefied phase in the lower region 40 of refrigerant storage tank 39 and in the upper region 41 thereof in its gaseous phase.

In liquid phase region 40, refrigerant storage tank 39 has a refrigerant outlet 42 that is above the refrigerant inlet 30 of heat exchanger 29 and that is in flow connection 43 with the latter.

A refrigerant level sensor 44 for measuring the filling level 45 of the liquefied phase of refrigerant 32 is arranged in refrigerant storage tank 39.

A feed valve 46 is disposed in feed line 37. The measurement signals from refrigerant level sensor 44 are routed to a valve controller 46a with which feed valve 46 can be brought into an open position or into a closed position. In the open position, reliquefied BOG is fed as refrigerant 32 into refrigerant storage tank 39. The filling level 45 of the liquefied phase of the refrigerant 32 in refrigerant storage tank 39 is controlled in such a way, by opening and closing feed valve 46, that the refrigerant outlet 42 of refrigerant storage tank 39 is always in liquid phase region 40. This ensures that heat exchanger 29 is supplied with sufficient refrigerant 32 at all times.

The refrigerant outlet 31 of heat exchanger 29 is in fluid connection 47 with feed line 37 downstream from feed valve 46, thus forming a refrigerant circuit 35 in which the liquid refrigerant 32 flows successively through refrigerant storage tank 39 and heat exchanger 29. Refrigerant circuit 35 operates like an ebullient cooling system.

In the embodiment shown in FIG. 2, compressor 2 is a two-stage compressor. The first compression stage 48 includes inlet 8 for the BOG stream 9 to be compressed and it compresses BOG stream 9 to an intermediate pressure that is lower than the final pressure. The second compression stage is the final compression stage 10 and compresses the intermediately compressed BOG stream to the final pressure and includes outlet 11 for the finally compressed BOG stream.

The gas phase region 41 of refrigerant storage tank 39 has an outlet 49 which is in fluid connection 50 with the BOG stream between the first compression stage 48 and the final compression stage 10. Evaporated refrigerant, i.e., gaseous BOG, can therefore be fed from refrigerant storage tank 39 into the BOG stream between the first compression stage 48 and the final compression stage 10. The intermediate pressure at the infeed point 51 between the first compression stage 10 and the final compression stage 10 also prevails in refrigerant storage tank 39 and thus in the entire refrigerant circuit 35. Feed valve 46 forms the boundary between the final pressure and the intermediate pressure in feed line 37.

Upstream from feed valve 46, fluid stream 9a and the finally compressed BOG stream 9 are under the final pressure, i.e., at a maximum below the predefined final pressure limit.

When the refrigerant 32 under the final pressure or final pressure limit is fed through feed valve 46 into refrigerant circuit 35, refrigerant 32 therefore expands to the intermediate pressure and cools down accordingly.

Due to the high pressure that the fluid stream 9a flowing from fluid receptacle 4 to heat exchanger 29 is under at the final pressure limit, and due to the relatively low temperature level in refrigerant circuit 35, fluid stream 9a is cooled down to a temperature close to the saturation temperature of fluid stream 9a at intermediate pressure, with the result that the gas phase fraction of fluid stream 9a is condensed in this state, and reliquefied BOG is exclusively or almost exclusively transferred through the open valve 7 (at the final pressure limit) into the fluid stream discharge line 7, for example is discharged into a tank.

As soon as the final pressure falls below the final pressure limit, this valve 6 is closed again until the liquid level setpoint 23 is reached again in fluid receptacle 4, and valve 6 is opened again.

The measures according to the invention for reliquefying BOG are illustrated below with a numerical example and with reference to the embodiment shown in FIG. 2. In the numerical example, the BOG to be reliquefied is discharged from a liquefied gas tank for propane, and condenser 3 is cooled by seawater. The liquid and gas compositions stated below, and the pressures and temperatures in the separate steps/apparatus element are based on flash calculations using NIST(National Institute of Standards and Technology) data:
a) In the liquefied gas tank from which BOG for reliquefaction is removed
   Liquid: Propane
      Ethane content 5 mol %
   BOG: Ethane content approx. 26 mol %
   Pressure: 1 bar a (100 kPa)
b) In two-stage compressor 2
   BOG stream: Ethane content approx. 26 mol %
   Intermediate pressure: 5 bar a (500 kPa)
   Final pressure: 21 bar a (2.1 MPa)

For the finally compressed BOG stream 9 discharged from compressor 2, the temperature for full condensation is approx. 25° C. for an ethane content of approx. 26 mol % and a pressure of 21 bar a (2.1 MPa).
c) In condenser 3
   On the refrigerant side:
      Seawater 28 with a water temperature of 32° C.,
         results, due to heat ingress in condenser 3, in a
      condensation tempera
         BOG stream 9 is only partly condensed, therefore.
On the gas/condensate side:
   Pressure (final pressure): 21 bar a (2.1 MPa)
   Incoming BOG stream 9: Ethane content approx. 26 mol %
   Discharged partly condensed fluid stream 9a:
      (large, approx. 97 mol % BOG) liquid content (condensate):
         Ethane content approx. 25 mol %
      (small, approx. 3 mol % BOG) non-condensed gas content:
         Ethane content approx. 45 mol %
d) In fluid receptacle 4
   Liquid content (condensate): Ethane content approx. 25 mol %
   Gas content: Ethane content approx. 45 mol %
   Pressure (final pressure): 21 bar a (2.1 MPa)
e) In cooling device 5
   On the refrigerant side:
      In feed line 37 upstream from feed valve 46
      Condensate: Ethane content approx. 25 mol %
      Pressure (final pressure): 21 bar a (2.1 MPa)
   In feed line 37 upstream from feed valve 46, i.e., in refrigerant circuit 35
      Pressure (intermediate pressure): 5 bar a (500 kPa) (expansion from final to intermediate pressure)
      Condensate: Temperature of approx. −6.5° C.
         Ethane content of approx. 8 mol %
   (the values for temperature and ethane content are set because part of the ethane evaporates due to the pressure drop, so the proportion of propane in the condensate increases.)

On the fluid side:
In the gas component: Ethane content of approx. 45 mol %
Pressure (final pressure): 21 bar a (2.1 MPa) (gas component is completely liquefied)

With an ethane content of approx. 45 mol % in the gas component on the fluid side and a temperature of approx. −6.5° C. on the refrigerant side, the saturation pressure for the gas component on the fluid side is approx. 10 bar a (1 MPa). Since the pressure on the fluid side is the final pressure of 21 bar a (2.1 MPa), the gas component in the fluid is completely liquefied.

1. A method for reliquefying boil-off gas (BOG) containing volatile components, the method comprising the following steps:
a) compressing a BOG stream (9), wherein the BOG stream (9) exits a final compression stage (10) as a finally compressed BOG stream (9) having a final pressure;
b) condensing the finally compressed BOG stream (9) to obtain an at least partly condensed, finally compressed fluid stream (9a);
c) providing a fluid receptacle (4) having a fluid stream inlet (15) and a fluid stream outlet (17), wherein the position of the fluid stream outlet (17) is selected such that it is above a predefined fluid containment volume (18);
d) feeding the fluid stream (9a) from step b) through the fluid stream inlet (15) into the fluid receptacle (4);
e) setting a liquid level setpoint (23) for the fluid receptacle (4) such that the liquid level setpoint (23) is at the level of the upper edge of the fluid stream outlet (17) or a predefined distance above it;
f) setting an upper final pressure limit for the final compression stage (10);
g) measuring the liquid level in the fluid receptacle (4);
h) measuring the final pressure;
i) discharging a fluid stream (9a) from the fluid receptacle (4) through the fluid stream outlet (17);
j) cooling the fluid stream (9a) from step i) to a temperature equal to the saturation temperature of the fluid stream (9a) at a pressure lower than the final pressure, in order to condense gaseous components of the fluid stream (9a);
k) transferring the cooled fluid stream (9b) when the measured liquid level is at least equal to the liquid level setpoint (23) and/or when the measured final pressure is equal to the final pressure limit.

2. The method according to claim 1, characterized in that step j) includes the following steps:
j1) providing a refrigerant circuit (35) in which a refrigerant (32) flows through a heat exchanger (29);
j2) feeding the fluid stream (9a) from step i) into the heat exchanger (29); and in that step k) includes discharging the cooled fluid stream (9b) from the heat exchanger (29).

3. The method according to claim 2, characterized in that
step j1) includes providing a refrigerant circuit (35) in which a liquid refrigerant (32) flows through the heat exchanger (29); and in that
step j1) further includes storing the refrigerant (32) in a refrigerant storage tank (39), wherein the refrigerant (32) in the lower region (40) of the refrigerant storage tank (39) is in its liquefied phase and in the upper region (41) is in its gaseous phase.

4. The method according to claim 3, characterized in that
step j1) includes storing the refrigerant (32) in a refrigerant storage tank (39) which is structurally separate from the heat exchanger (29).

5. The method according to claim 3, characterized in that
step j1) includes integrating the refrigerant storage tank (39) in the heat exchanger (29).

6. The method according to any one of claims 3 to 5, characterized in that in step a) the BOG stream (9) is compressed in at least two compression stages (48, 10); and in that
step j1) also includes the following steps:
j1.1) feeding a liquid stream as refrigerant (32) from the fluid receptacle (4) into the refrigerant circuit (35) by means of a feed line (37);
j1.2) arranging a feed valve (46) in the feed line (37) and opening the feed valve (46) for feeding in and otherwise keeping the feed valve (46) closed;
j1.3) establishing a flow connection (50) between the gas phase region (41) of the refrigerant storage tank (39) and the BOG stream (9) between the first compression stage (48) and the final compression stage (10), in order to feed evaporated refrigerant into said BOG stream (9) and to set a pressure in the refrigerant circuit (35) equal to the intermediate pressure at the infeed point (51) and thus lower than the final pressure.

7. The method according to claim 6, characterized in that in step j1.1) the liquid stream is removed from the fluid receptacle (4) at the bottom thereof.

8. The method according to claim 4 or according to claim 4 and one of claims 6 or 7, characterized in that the discharge point (42) of the liquid refrigerant (32) from the refrigerant storage tank (39) is placed above the inlet (30) of the refrigerant (32) into the heat exchanger (29).

9. The method according to any one of the preceding claims, characterized in that an ebullient cooling system is used in step j) for cooling.

10. The method according to any one of the preceding claims, characterized in that condensing in step b) is by means of seawater (28).

11. An apparatus for carrying out the method according to any one of claims 1 to 10, comprising
a compressor (2)
that has an inlet (8) for a BOG stream (9) and
the final compression stage (10) of which finally compresses the BOG stream (9) to a final pressure and has a BOG stream outlet (11) for the finally compressed BOG stream (9),
a condenser (3)
that has a BOG stream inlet (12) in flow connection (13) with the BOG stream outlet (11) of the final compression stage (10) and
is configured to at least partly condense the finally compressed BOG stream (9) into a fluid stream (9a) and
has a fluid stream outlet (14);
a fluid receptacle (4) that has
a fluid stream inlet (15) in flow connection (16) with the fluid stream outlet (14) of the condenser (3) and
a fluid stream outlet (17) which is above the predefined fluid containment volume (18);
a level sensor (24) for measuring the liquid level in the fluid receptacle (4),
a pressure sensor (27) for measuring the final pressure;
a cooling device (5) that
has a fluid stream inlet (19) in fluid connection (20) with the fluid stream outlet (17) of the fluid receptacle (4), and
has a fluid stream outlet (25) for the cooled fluid stream (9b) and
is configured to cool the fluid stream (9a) to a temperature equal to the saturation temperature of the fluid stream (9a) at a pressure lower than the final pressure, in order to condense gaseous components of the fluid stream (9a);
an actuator (6) that
is in fluid connection (26) with the fluid stream outlet (25) of the cooling device (5) and
can be brought into an open position when the measured liquid level is at least equal to the liquid level setpoint (23) and/or when the measured final pressure is equal to a predefined final pressure limit, in order to transfer the cooled fluid stream (9b), and
can otherwise be brought into a closed position in which it pauses the cooled fluid stream (9b).

12. The apparatus according to claim 11, characterized in that the actuator is a valve (6).

13. The apparatus according to claim 11 or 12, characterized in that the cooling device (5) has a refrigerant circuit (35) in which a refrigerant (32) flows through a heat exchanger (29), wherein the heat exchanger (29) has a fluid stream inlet (33) in fluid connection (20) with the fluid stream outlet (17) of the fluid receptacle (4), and a fluid stream outlet (34) forming the fluid stream outlet (25) of the cooling device (5).

14. The apparatus according to claim 13, characterized in that the refrigerant (32) flowing through the heat exchanger (29) is liquid and the refrigerant circuit (35) has a refrigerant storage tank (39), wherein the refrigerant (32) in the lower region (40) of the refrigerant storage tank (39) is in its liquefied phase and in the upper region (41) is in its gaseous phase.

15. The apparatus according to claim 14, characterized in that the refrigerant storage tank (39) and the heat exchanger (29) are structurally separate from each other.

16. The apparatus according to claim 14, characterized in that the refrigerant storage tank (39) is integrated in the heat exchanger (29).

17. The apparatus according to any one of claims 14 to 16, characterised in that the compressor (2) is an at least two-stage compressor, the first compression stage (48) having the inlet (8) for a BOG stream (9), and in that the cooling device (5) further comprises
a feed line (37) that connects an inlet of the refrigerant circuit (35) for the liquid refrigerant (32) to an outlet (36) of the fluid receptacle (4) for a liquid stream;
a feed valve (46) which is disposed in the feed line (37) and which can be brought into an open position for feeding the liquid stream, and can otherwise be brought into a closed position;
a conduit (50) for establishing a flow connection between the gas phase region (41) of the refrigerant storage tank (39) and the BOG stream (9) between the first compression stage (48) and the final compression stage (10), in order to feed evaporated refrigerant into said BOG stream (9) and to set a pressure in the refrigerant circuit (35) equal to the intermediate pressure at the infeed point (51) and thus lower than the final pressure.

18. The apparatus according to claim 17, characterized in that the outlet (36) of the fluid receptacle (4) for a liquid stream (32) is embodied in the bottom of the fluid receptacle (4).

19. The apparatus according to claim 15 or according to claim 15 and one of claims 17 or 18, characterized in that the outlet (42) of the liquid refrigerant (32) from the refrigerant storage tank (39) is placed above the inlet (30) of the refrigerant (32) into the heat exchanger (29).

20. The apparatus according to any one of claims 11 to 19, characterized in that the cooling device (5) is an ebullient cooling system.

21. The apparatus according to any one of claims 11 to 20, characterized in that the refrigerant of the condenser (3) is seawater (28).

22. A vessel having an apparatus according to any one of claims 11 to 21.
